(19) United States
(12) Patent Application Publication
(10) Pub. No.: US 2015/0020360 A1
(43) Pub. Date: Jan. 22, 2015

(54) METHOD OF REMOVING A BUSHING FROM A MACHINE COMPONENT

(71) Applicant: Caterpillar Inc., Peoria, IL (US)

(72) Inventor: James C. Nanney, Booneville, MS (US)

(73) Assignee: Caterpillar Inc., Peoria, IL (US)

(21) Appl. No.: 14/510,198

(22) Filed: Oct. 9, 2014

(51) Int. Cl. B25B 27/06

(52) U.S. Cl. CPC B25B 27/062
USPC 29/426.5

(57) ABSTRACT

A method of removing a bushing secured within a blind hole defined in a machine component is disclosed. The method includes inserting a cylindrical portion of a tool at least partly in an opening adjacent to the blind hole. The method includes positioning an elongate member of the tool that extends from the cylindrical portion co-axially with the blind hole. The elongate member includes four corner portions disposed at an end distal to the cylindrical portion and defines an effective diameter of the elongate member less than a diameter of the blind hole. The method includes driving the block member towards the machine component to insert the elongate member into the blind hole, separating the bushing into at least four parts via the corner portions, removing the elongate member from the blind hole, and removing the parts from the blind hole.

### TECHNICAL FIELD

The present disclosure generally relates to a method of removing a bushing from a machine component. More particularly, the present disclosure relates to a method of removing a bushing secured within a blind hole defined by the machine component.

### BACKGROUND

Many machine components include one or more bushings that may be secured within holes. Typically, the bushings may be press-fitted into the holes. These bushings may have to be removed from the respective holes for replacement. In some cases, the bushings may be removed as part of a remanufacturing or servicing process of the machine component.

Although methods are known to remove the bushings from holes in a machine component, such methods may require considerable manual effort and time. One such method includes using a hand tap to remove the bushing. Such a process requires an operator to apply a force to disassemble the bushing. The bushing is then extracted by manually pulling the tap. However, it may be difficult to secure the tap to the bushing due to a material property of the bushing. Conventional removal methods may be implementable on only one bushing at a time, thereby increasing the time and effort required.

For reference, U.S. Pat. No. 6,484,391 discloses a bushing installation and removal assembly. The assembly includes a mounting table fitted with a vice fixture, and a press/ram assembly having a controlled hydraulic press. A separate hydraulic repositioning system disposes the work piece into the press/ram assembly in a controlled manner. The worktable, fixtures and press/ram assembly are designed to receive and securely position the housing assembly (work piece) onto a controlled substrate. The substrate is then designed to re-position the housing assembly (work piece) proximate to the press ram, which suitably presses the bushing member onto the housing assembly (work piece). The substrate is then retracted to its original position where the housing assembly (work piece) is removed for further processing.

### SUMMARY OF THE DISCLOSURE

In an aspect of the present disclosure, a method of removing a carbon bushing secured within a blind hole defined in a machine component is provided. The method includes inserting a cylindrical portion of a tool at least partly in an opening adjacent to the blind hole. The cylindrical portion extends from a block member of the tool along a longitudinal axis. The method includes positioning an elongate member of the tool to be co-axial with the blind hole. The elongate member extends from the cylindrical portion along the longitudinal axis. The elongate member includes four corner portions disposed at an end distal to the cylindrical portion. The elongate member also defines four grooves along a length thereof. The grooves are provided between adjacent pairs of the four corner portions. Further, the end of the elongate member has a surface that is concave relative to the four corner portions. The method further includes driving the block member towards the machine component to insert the elongate member into the blind hole. The four corner portions define an effective diameter of the elongate member that is less than a diameter of the blind hole. The method also includes separating the carbon bushing into at least four parts via the four corner portions of the elongate member. The at least four parts of the carbon bushing are at least partly received in the grooves. The method includes removing the elongate member from the blind hole, and removing the parts of the carbon bushing from the blind hole.

Other features and aspects of this disclosure will be apparent from the following description and the accompanying drawings.

### BRIEF DESCRIPTION OF THE DRAWINGS

FIG. 1 is a partial sectional side view of an exemplary machine component having installed bushings and a tool configured to remove the bushings from the machine component, according to an embodiment of the present disclosure;

FIG. 2 is a perspective view of the tool showing a first elongate member and a second elongate member, according to an embodiment of the present disclosure;

FIG. 3 is a partial sectional view of the tool being inserted into the machine component;

FIG. 4 is a partial sectional view of the machine component that is in a tilted position showing separated parts of first and second bushings; and

FIG. 5 is a flowchart illustrating a method of removing first and second bushings from the machine component, according to an embodiment of the present disclosure.

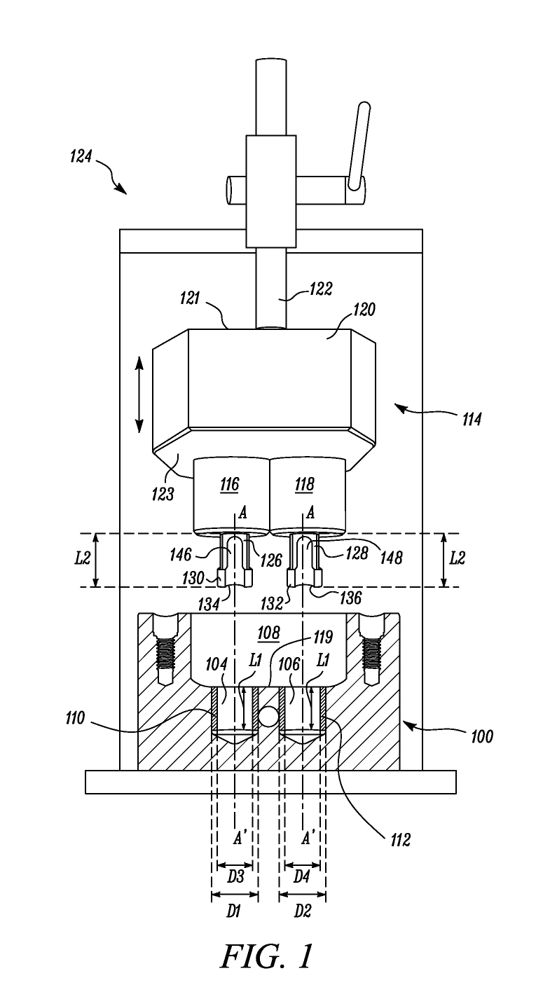

### DETAILED DESCRIPTION

Wherever possible, the same reference numbers will be used throughout the drawings to refer to same or like parts. FIG. 1 illustrates an exemplary machine component 100. The machine component 100 may be a component of a transfer pump. In an example, the machine component 100 may be a top plate of the transfer pump. The transfer pump may be used with internal combustion engines to provide a flow of fuel.

The machine component 100 defines a first blind hole 104 and a second blind hole 106 that may be configured to rotatably receive corresponding shafts (not shown) therein. Each of the first and second blind holes 104, 106 define a longitudinal axis A-A′. Further, the first and second blind holes 104, 106 may have diameters D1 and D2, respectively. The machine component 100 may define an opening 108 adjacent to the first and second blind holes 104, 106.

The machine component 100 further includes a first carbon bushing 110 (hereinafter referred as ‘the first bushing 110’) and a second carbon bushing 112 (hereinafter referred as ‘the second bushing 112’) that are secured within the first blind hole 104 and the second blind hole 106, respectively. The first and second bushings 110, 112 may be made of carbon based material, such as graphite. .The first and second bushings 110, 112 may provide bearing surfaces for rotation of the corresponding shafts. In an example, the first and second bushings 110, 112 may be secured within the first and second blind holes 104, 106, respectively by interference fits. In the illustrated embodiment of FIG. 1, each of the first and second bushings 110, 112 may have a length L1. Further, the first and second bushings 110, 112 have inner diameters D3, D4, respectively. The inner diameters D3, D4 may be substantially equal.

Although, the machine component 100 is embodied as a top plate of a transfer pump, it may be contemplated that the machine component 100 may be any other component defining one or more blind holes that include bushings secured within.

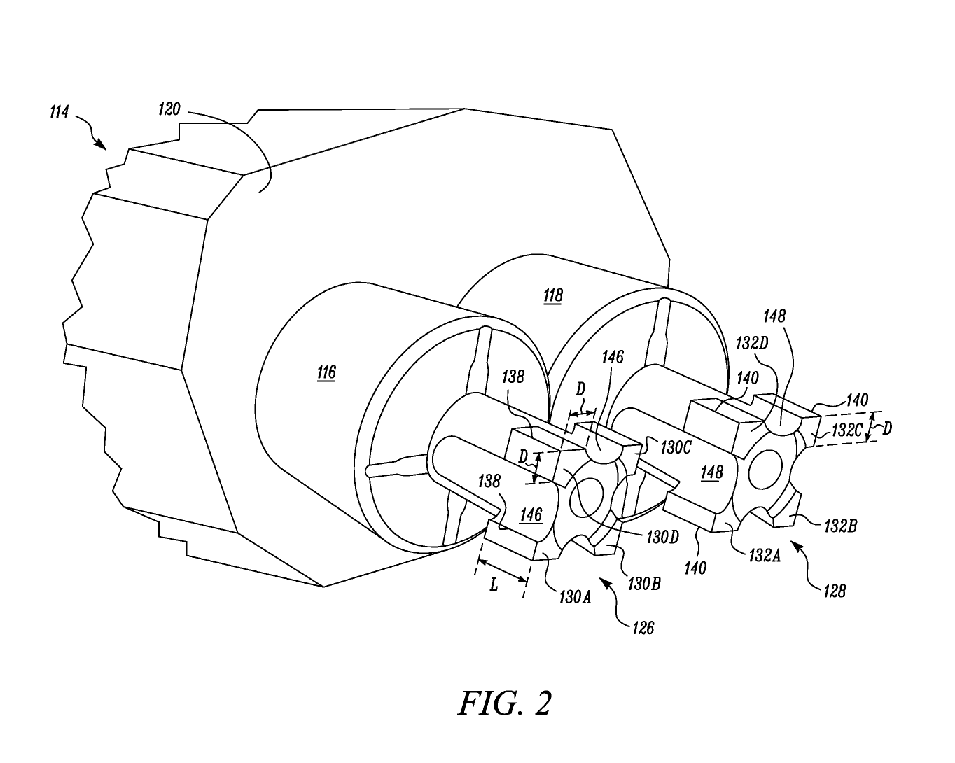

Referring to FIGS. 1 and 2, a tool 114 is shown that may be employed to remove the first and the second bushings 110, 112 from the first and second blind holes 104, 106, according to an embodiment of the present disclosure. The tool 114 and a method of using the tool 100 to remove the first and second bushings 110, 112 will be explained hereinafter with reference to FIGS. 1 to 5.

As shown in FIG. 1, the tool 114 includes a block member 120 configured to be driven by a press 124. The press 124 may be configured to drive the tool 114 towards the machine component 100. The press 124 may also be configured to retract the tool 114 away from the machine component 100. Accordingly, a driving member 122 of the press 124 may be coupled to the block member 120. The driving member may be disposed adjacent to a top surface 121 of the block member 120 and along the longitudinal axis A-A′. Based on a movement of the driving member 122, the tool 114 may be driven towards or away from the machine component 100.

In one embodiment, the press 124 may be a hydraulic press. In another embodiment, the press 124 may be an arbor press. However, a person of ordinary skill will recognize that the press 124 may embody any device known in the art that is configured to drive the tool 114 towards and away from the machine component 100.

Further, the tool 114 includes a first cylindrical portion 116 and a second cylindrical portion 118 extending from a bottom surface 123 of the block member 120 along the longitudinal axis A-A′. The first and second cylindrical portions 116, 118 are configured to be inserted at least partly in the opening 108 adjacent to the first and second blind holes 104, 106. Upon further driving of the tool 114 towards the machine component 100, the cylindrical portions 116, 118 may be configured to abut a top end 119 of the machine component 100 that is adjacent to the first and second blind holes 104, 106. The first and second cylindrical portions 116, 118 may be configured to support the tool 114 on the top end 119. Accordingly, the first and second cylindrical portions 116, 118 may have diameters greater than the diameters D1 and D2 of the first and second blind holes 104, 106, respectively.

Although, the first and second cylindrical portions 116, 118 are shown abutting each other, it may be contemplated that the first and second cylindrical portions 116, 118 may be spaced apart from each other depending on a design of the machine component 100.

The tool 114 also includes a first elongate member 126 and a second elongate member 128 that are disposed along the longitudinal axis A-A′. The first elongate member 126 and the second elongate member 128 extend from the first cylindrical portion 116 and the second cylindrical portion 118, respectively. Further, the tool 114 may be positioned such that the first and second elongate members 126, 128 may be co-axial with the first blind hole 104 and the second blind hole 106, respectively.

Moreover, the first and second elongate members 126, 128 may be configured to be inserted into the first and second blind holes 104, 106, respectively upon driving the tool 114 towards the machine component 100. Further, a length L2 (shown in FIG. 1) of each of the first and second elongate members 126, 128 may be greater than or equal to the length L1 of the first and second bushings 110, 112.

In one embodiment, at least one of the first and second elongate members 126, 128 may be removably coupled to the corresponding first and second cylindrical portions 116, 118. In such a case, by detaching one of the first and second elongate members 126, 128 from the corresponding first and second cylindrical portions 116, 118, the tool 114 may be beneficially employed to remove only one bushing secured within a blind hole.

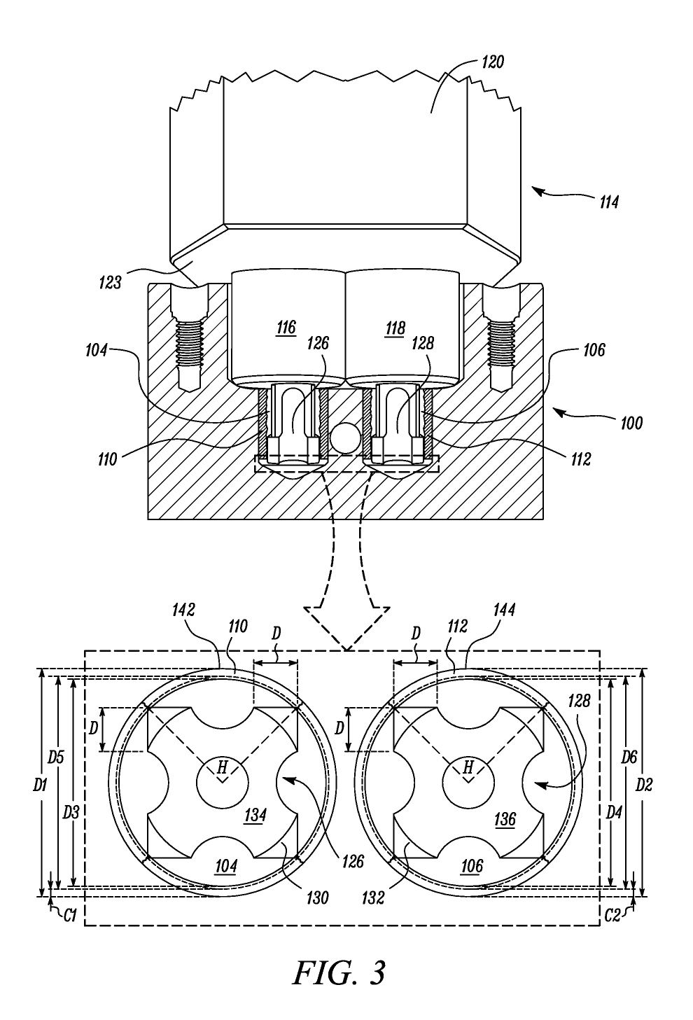

Referring to FIGS. 2 and 3, the first elongate member 126 includes four corner portions 130A, 130B, 130C, 130D (collectively referred to as ‘the corner portions 130’) that are disposed adjacent to an end 134 of the first elongate member 126 distal to the first cylindrical portion 116. Similarly, the second elongate member 128 includes four corner portions 132A, 132B, 132C, 132D (collectively referred to as ‘the corner portions 132’) that are disposed adjacent to an end 136 of the second elongate member 128 distal to the second cylindrical portion 118.

In the illustrated embodiment, an angle H between adjacent pairs of the corner portions 130, 132 may be substantially ninety degrees. Further, each of the corner portions 130, 132 may have respective outer edges 138, 140 that extend to a length L along the longitudinal axis A-A′. Moreover, each of the corner portions 130, 132 may extend to a depth D perpendicular to the longitudinal axis A-A′.

The corner portions 130, 132 may be configured to separate the first and second bushings 110, 112 into at least four parts 135A, 135B, 135C, 135D (collectively referred to as ‘the parts 135’) and 137A, 137B, 137C, 137D (collectively referred to as ‘the parts 137’), respectively. More specifically, the outer edges 138, 140 of the corner portions 130, 132 may serve as cutting edges configured to cut through the respective bushings 110, 112.

As illustrated in FIG. 3, the outer edges 138 of the corner portions 130 may define an effective diameter D5 of the first elongate member 126. Similarly, the outer edges 140 of the corner portions 132 may define an effective diameter D6 of the second elongate member 128. The effective diameters D5, D6 may be greater than the inner diameters D3, D4 of the first and second bushings 110, 112, respectively. With such a configuration, the outer edges 138, 140 may cut the respective bushings 110, 112 while moving inside the corresponding blind holes.

The effective diameters D5, D6 may be selected so as to provide a clearance C1, C2 between the corner portions 130, 132 and walls 142, 144 of the first and second blind holes 104, 106 respectively. Accordingly, the effective diameters D5, D6 are lesser than the diameters D1, D2 of the first and second blind holes 104, 106 respectively. Moreover, the clearances C1, C2 may be in the range of 0.01 to 0.02 inch. By providing such clearances C1, C2, contact between the corner portions 130, 132 and the corresponding walls 142, 144 may be avoided when the corner portions 130, 132 travel inside the respective blind holes 104, 106.

Each of the first and second elongate members 126, 128 further define grooves 146, 148 between each of the adjacent corner portions 130, 132. The grooves 146, 148 extend along lengths L2 of the first and second elongate members 126, 128, respectively. The grooves 146, 148 may be curvilinear in shape. The grooves 146, 148 may be configured to receive at least partly the separated parts 135, 137 of the bushings 110, 112 therein.

Each of the ends 134, 136 of the first and second elongate members 126, 128 has a surface that is concave relative to the corresponding corner portions 130, 132. Therefore, upon driving the tool 114 towards the blind holes 104, 106, the corner portions 130, 132 may first contact the bushings 110, 112. Further, the curvatures of the ends 134, 136 may minimize contact between the elongate members 126, 128 and bottom walls of the corresponding blind holes 104, 106 when the elongate members 126, 128 are fully inserted therein.

Although, the corner portions 130, 132 are shown to have a substantially square shape, it may be contemplated to provide different shapes for the corner portions 130, 132 such as, but not limited to, triangular, curvilinear, and the like. Further, dimensions and shapes of the corner portions 130, 132, the elongate members 126, 128 and other portions of the tool 114 may be selected based on dimensions, configuration and number of blind holes, and corresponding bushings that have to be removed.

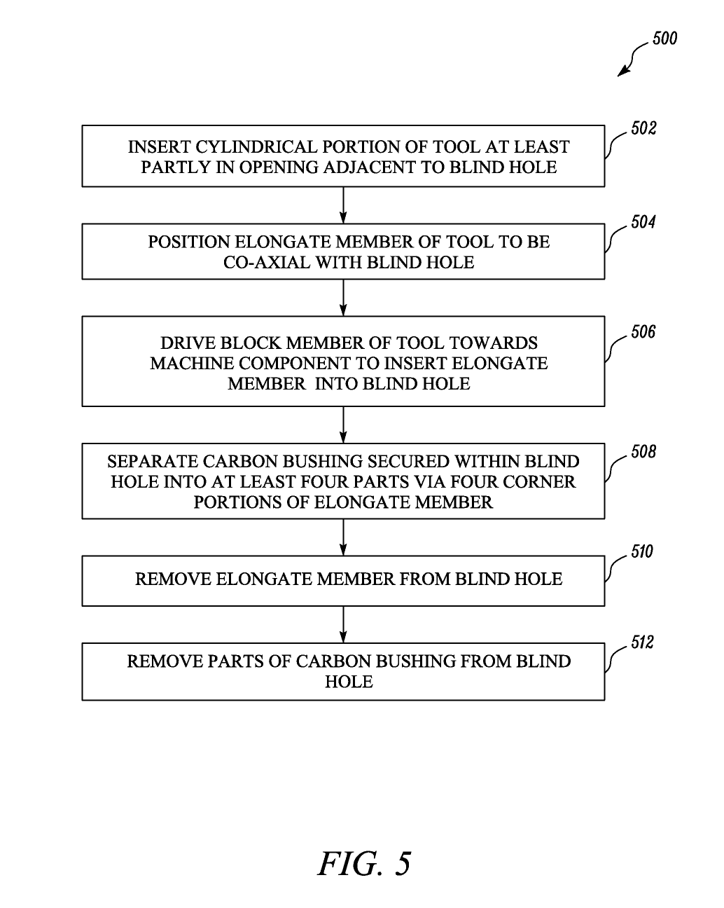

Referring to FIG. 5, a method 500 of removing a bushing secured within a blind hole is illustrated. The method 500 will be explained herein with reference to the machine component 100 and the tool 114 illustrated in FIGS. 1 to 4. The tool 114 may be used to remove the first and second bushings 110, 112 secured within the first and second blind holes 104, 106 defined in the machine component 100. However, a person of ordinary skill in the art will acknowledge that the tool 114 and the machine component 100 illustrated are merely exemplary in nature, and variations are possible within the scope of the present disclosure.

At step 502, the method 500 includes inserting the first and second cylindrical portions 116, 118 at least partly in the opening 108 adjacent to the first and second blind holes 104, 106. At step 504, the method 500 includes positioning the first and second elongate members 126, 128 to be co-axial with the first and second blind holes 104, 106, respectively.

At step 506, the method 500 includes driving the block 120 towards the machine component 100 so as to insert the first and second elongate members 126, 128 into the first and second blind hole 104, 106 respectively. The tool 114 may be driven towards the first and second bushings 110, 112 by the press 124. As the tool 114 is driven towards the machine component 100, the first and second elongate members 126, 128 are inserted into the first and second blind holes 104, 106, respectively.

The driving of the block member 120 relative to the machine component 100 may be continued until the corner portions 130, 132 of the first and second elongate members 126, 128 travels the entire length L1 of the first and second bushings 110, 112. At this position, the first and second cylindrical portions 116, 118 may be supported on the top end 119 of the first and second blind holes 104, 106, as shown in FIG. 3.

At step 508, the method 500 includes separating each of the first and second bushings 110, 112 into at least the four parts 135A, 135B, 135C, 135D, and 137A, 137B, 137C, 137D via the corner portions 130, 132. The effective diameters D5, D6 of the first and second elongate members 126, 128 may be greater than the diameters D3, D4 of the first and second bushings 110, 112, respectively. Therefore, as the tool 114 is being driven through the blind holes 104, 106, the corner portions 130, 132 may cut through the bushings 110, 112. Further, the separated parts 135A, 135B, 135C, 135D, and 137A, 137B, 137C, 137D are at least partly received in the grooves 146, 148 defined in the first and second elongate members 126, 128, respectively.

Further, the effective diameters D5, D6 of the first and second elongate members 126, 128 may be less than the diameters D1, D2 of the first and second blind holes 104, 106, respectively. Therefore, as the tool 114 is being driven through the blind holes 104, 106, contact between the tool 114 and the corresponding walls 142, 144 of the blind holes 104, 106 may be avoided.

At step 510, the method 500 includes removing the first and second elongate members 126, 128 from the first and second blind holes 104, 106, respectively. The press 124 may be employed to remove the first and second elongate members 126, 128 from the first and second blind holes 104, 106, respectively, by driving the tool 114 away from the machine component 100.

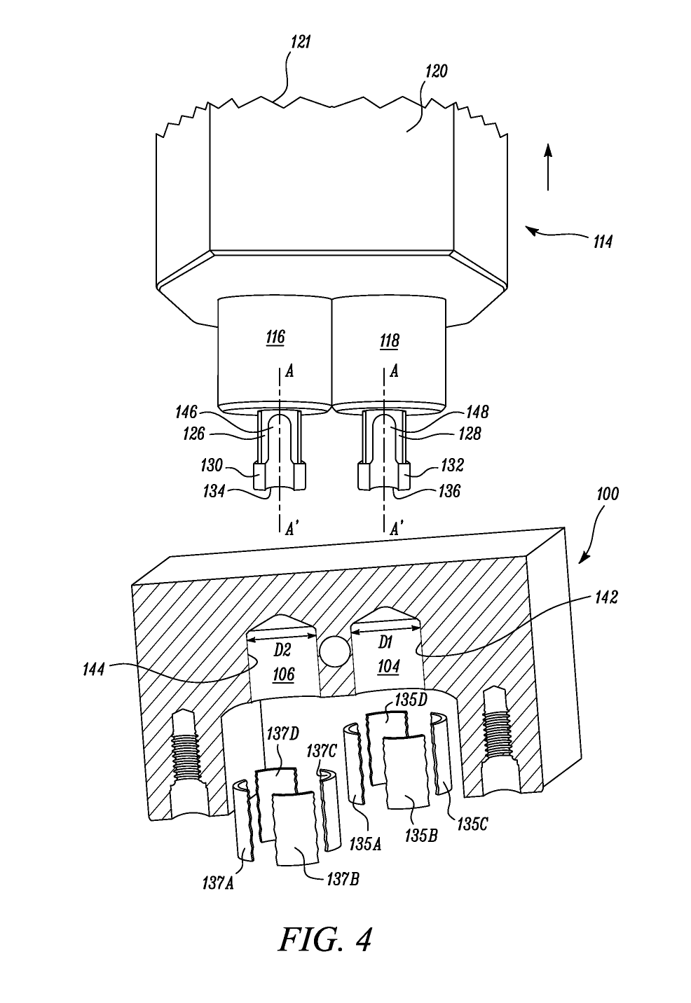

At step 512, the method 500 includes removing the parts 135, 137 of the first and second bushing 110, 112 from the first and second blind holes 104, 106, respectively. In the illustrated embodiment of FIG. 4, the machine component 100 may be tilted downwards to allow the separated parts 135A, 135B, 135C, 135D, and 137A, 137B, 137C, 137D of the first and second bushings 110, 112 to fall out of the respective first and second blind holes 104, 106. The machine component 100 may be tilted manually or automatically. However, it may be contemplated to use other methods and/or devices commonly known in the art to extract and/or remove the separated parts 135, 137 from the first and second blind holes 104, 106.

Although, the method 500 is explained in conjunction with the machine component 100, it may be envisioned to implement the method 500 to remove one or more carbon bushings from corresponding blind holes defined in various machine components. It may be also be contemplated to modify the tool 114 or use a different tool to implement one or more steps of the method 500. For example, a tool having one elongate member may be used to implement the steps of the method 500 to remove only one bushing.

### INDUSTRIAL APPLICABILITY

The method 500 of the present disclosure has applicability for use and implementation in removing one or more bushings secured within blind holes defined in various types of machine components. Removal of such bushings may be required for replacement purposes. Additionally, removal of the bushings may be necessary for servicing or remanufacturing of the machine components. With implementation of the method 500 disclosed herein, bushings may be removed from multiple blind holes at the same time, thereby saving time and/or effort.

Additionally, the tool 114 that is associated with the implementation of the method 500 may have a simple construction and may also be easily manufactured and/or customized to suit various applications. Further, the tool 114 may be used repeatedly in one or more applications for implementing the method 500.

Using a device such as the press 124 to drive the tool 114 towards the machine component 100 may increase efficiency of the method 500 with respect to time and accuracy, and minimizes manual effort. Moreover, after the first and second bushings 110, 112 are separated, a simple operation such as, tilting the machine component 100 upside down may allow the separated parts 135, 137 to fall off from the first and second blind holes 104, 106. The tool 114 may also be sized so as to minimize any damage to other parts of the machine component 100 during removal of the first and second bushings 110, 112.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of removing a carbon bushing secured within a blind hole defined in a machine component, the method comprising:
inserting a cylindrical portion of a tool at least partly in an opening adjacent to the blind hole, wherein the cylindrical portion extends from a block member of the tool along a longitudinal axis;
positioning an elongate member of the tool to be co-axial with the blind hole, wherein the elongate member extending from the cylindrical portion along the longitudinal axis, the elongate member comprising four corner portions disposed at an end distal to the cylindrical portion, the elongate member defining four grooves along a length thereof and provided between adjacent pairs of the four corner portions, and wherein the end of the elongate member has a surface concave relative to the four corner portions;
driving the block member towards the machine component to insert the elongate member into the blind hole, wherein the four corner portions define an effective diameter of the elongate member that is less than a diameter of the blind hole;
separating the carbon bushing into at least four parts via the four corner portions of the elongate member, the at least four parts of the carbon bushing being at least partly received in the grooves;
removing the elongate member from the blind hole; and
removing the parts of the carbon bushing from the blind hole.
